(19) United States
(12) Patent Application Publication
(10) Pub. No.: US 2026/0275048 A1
(43) Pub. Date: Sep. 17, 2026

(54) LIGNIN EPOXIDE ADDUCT WITH THERMOPLASTIC PROPERTIES

(71) Applicant: METGEN OY, KAARINA (FI)

(72) Inventors: Petri Tapani IHALAINEN, KAARINA (FI); Liji Sobhana Seleenmary SOBHANADHAS, KAARINA (FI); Dmitry TARASOV, KAARINA (FI)

(21) Appl. No.: 19/168,064

(22) PCT Filed: Mar. 25, 2024
(86) PCT No.: PCT/EP2024/057900

§ 371 Date: Sep. 23, 2025

(30) Foreign Application Priority Data
Mar. 24, 2023 (EP) 23163967.5

(51) Int. Cl. C08H 7/00

(52) U.S. Cl. CPC C08H 6/00

(57) ABSTRACT

The invention relates to methods of producing lignin epoxide adduct with thermoplastic properties. In particular the invention describes a method which can be performed under mild conditions, to obtain a lignin epoxide adduct with a low percentage of homopolymer of epoxide. The invention further relates to compositions and lignin epoxide adduct obtained using the described method.

### BACKGROUND OF THE INVENTION

Being an abundant and renewable polymer, lignin has the potential to be used in different application areas, such as in adhesives, binders, castings, foams (such as in rigid polyurethane and polyisocyanurate foams for thermal insulation and construction applications, semi-rigid, flexible, molded, laminated, microcellular and viscoelastic polyurethane foams), fillers, glues, sealants, elastomers, and rubbers as well as in biobased plastic and composite materials. As an amorphous material, lignin has a relatively high glass-transition temperature and also undergoes radical-induced self-condensation at high temperatures, which limits its thermal processability. Additionally, lignin-based materials are usually brittle and exhibit poor mechanical properties.

Lignin (CAS Number 9005-53-2) is a class of complex organic polymers that form key structural materials in the support tissues of vascular plants and some algae. Lignins are particularly important in the formation of cell walls, especially in wood and bark, because they lend rigidity and do not rot easily. Chemically, lignins are cross-linked phenolic polymers. As a biopolymer, lignin is unusual because of its heterogeneity and lack of a defined primary structure. Its most commonly noted function is the support through the strengthening of wood. Lignin is a cross-linked polymer with a very diverse size distribution, wherein the largest molecules have a molecular weight in excess of 100 000 Dalton (Da). It is relatively hydrophobic and rich in aromatic subunits. The transformation of lignin into value-added thermoplastic materials is expected to provide cost-effective and biodegradable alternatives for petroleum-based thermoplastics. Lignin is usually isolated from lignocellulosic biomass by either “dissolving” lignin through chain scission or removing carbohydrate components by enzymatic hydrolysis. In general, all lignin isolation processes, including enzymatic, chemical, and mechanical methods, cause structural alterations and chain scissions of native lignin.

Most of the technical lignins are byproducts derived from the paper and pulp industry. The dominant industrial pulping processes are kraft, and sulfite, less widespread are organosolv processes and other biomass processing processes. The reaction conditions of these isolation processes are usually harsh with high temperatures, high pressures, and high (or low) pH values, so the chemical structures and linkages of the native lignin are altered during isolation. Therefore, industrial lignin may have different properties depending on the plant species and the preparation method.

The main characteristics of lignin are its average molecular weight. Lignins with low and high molecular weights are usually obtained by fractionation based on solubility in organic solvents (e.g., methanol or acetone). Other methods of size separation such as membrane ultrafiltration are also applicable to lignin. Ultrafiltration is a variety of membrane filtration in which forces such as pressure or concentration gradients lead to a separation through a semipermeable membrane. Suspended solids and solutes of high molecular weight are retained in the so-called retentate, while water and low molecular weight solutes pass through the membrane in the permeate (filtrate). Ultrafiltration membranes are characterized by a cut-off molecular weight, which determines the molecular weight of the molecules which will penetrate the membrane.

### SUMMARY OF THE INVENTION

The current invention relates to a method of obtaining a Lignin epoxide adduct (EpL) with thermoplastic properties which is achieved by reacting lignin with an epoxide (as depicted in FIG. 1).

A non-limiting example of epoxide addition is the addition reaction between lignin and alkylene oxide. This kind of epoxide addition is also called hydroxy alkylation or alkoxylation. Hydroxy alkylation of lignin has been recognized as a promising technique for overcoming lignin's poor solubility and its frequently observed adverse effects on the mechanical properties of solid polymers. Hydroxy alkylation of lignin may result in reducing the brittleness of lignin-derived polymers, and in improving viscoelastic properties in various end uses.

Epoxide addition allows in some instances a transition of the solid lignin to a thermoplastic material which is highly desirable for the polymer industry. However, this transition to a thermoplastic material so far could only be achieved under harsh reaction conditions such as high pressure and high temperature (above 100° C.). These harsh conditions result not only in epoxide addition to lignin but also in homo-polymerization of the epoxide. This results in longer polyether chains covalently attached to EpL as depicted in FIG. 1B, as well as free homopolymer chains of the epoxide in the reaction mixture. Thus, such harsh epoxide addition results in a copolymer combining covalently bound high-modulus (high stiffness) lignin with a lower-modulus (low stiffness) polyether phase (FIG. 1A, B). As a consequence, the degree of process control for the EpL synthesis is severely reduced and the formulation latitude is more or less lost due to difficulties to assess how much homopolymer is formed. Besides high-pressure chemical processes require special equipment and are difficult to bring to a large scale. Alternatively, mild epoxide addition to lignin (atmospheric pressure, temperatures below 100° C.) has been applied in some cases, which does not result in the homo-polymerization of the epoxide. It decorates lignin with monomeric epoxide units as depicted in FIG. 1C, providing a more chemically homogeneous material and controllable process. However, this degree of chemical modification of lignin so far did not result in the transition of the lignin to a thermoplastic material.

It is desirable for the industry to be able to obtain chemically modified lignin with thermoplastic properties by scalable and controllable methods.

We have surprisingly found that lignin with particular properties such as low molecular weight and most importantly low polydispersity index, can be converted to EpL with thermoplastic properties by mild epoxide addition. To our best knowledge, this is the first report of EpL with thermoplastic properties obtained by mild epoxide addition. Moreover, EpL obtainable by the method disclosed in this invention is chemically different from thermoplastic EpL obtainable by harsh epoxide addition. More specifically EpL obtainable by the method disclosed in this invention contains predominantly monomeric epoxide units covalently attached to lignin, whereas EpL obtainable by harsh epoxide addition contains predominantly homopolymeric epoxide units covalently attached to lignin. Thus, the current invention also relates to a composition obtainable by the method disclosed here.

### DETAILED DESCRIPTION OF THE INVENTION

### Legends to Figures:

FIG. 1 Schematic representation of methods of obtaining EpL.
A—schematic representation of lignin (OH-connected to a black hexagon-phenolic hydroxyl groups) and epoxide
B—Lignin epoxide adduct EpL with thermoplastic properties obtainable by harsh epoxide addition described in the prior art.
C—EpL obtainable by mild epoxide addition described in the prior art, this EpL has no thermoplastic properties.
D—EpL obtainable by the mild epoxide addition method described in the current invention, the EpL is characterized by thermoplastic properties.

FIG. 2A-Mild Lignin epoxide addition reaction, B—mild epoxide addition reaction in the presence of water and access of epoxide

FIG. 3: Experimental set-up for the selective and continuous removal of low molecular weight lignin molecules in a bioreactor.

Lignin is the second major component of wood and annual plants. It is a cross-linked and irregular macromolecule comprising hydrophobic aromatic moieties and hydrophilic hydroxyl groups, whose structure varies with the vegetable species. Chemically unmodified lignin in the absence of solvents or dispersants is a solid compound. Solubility and dispersibility of lignin largely depend on the lignin preparation methods and the balance of hydrophobic and hydrophilic moieties.

Lignin is usually characterized by the average molecular weight and polydispersity index.

There are two different parameters describing the average molecular weight of a polymer: the number average molecular weight (Mn) and the weight average molecular weight (Mw). The number average molecular weight (Mn) is the statistical average molecular weight of all the polymer chains in the sample and is defined by the formula Mn=ΣNᵢMᵢ/ΣNᵢ. The weight average molecular weight (Mw) is defined by the formula: Mw=ΣNᵢMᵢ²/ΣNᵢMᵢ, where Mᵢ is the molecular weight of a chain and Nᵢ is the number of chains of that molecular weight.

Mw and Mn can be calculated from the molecular weight profile obtained by size-exclusion chromatography, more preferably high-performance size-exclusion liquid chromatography (SEC-HPLC).

The polydispersity index (PDI) is used as a measure of the broadness of a molecular weight distribution of a polymer, and is defined by the formula: PDI=Mw/Mn. The larger the polydispersity index, the broader the molecular weight, and inversely—the closer the PDI value is to 1, the more uniform the size of the molecules in the sample. A monodisperse polymer is a polymer where all the chain lengths are equal (such as a protein). A monodisperse polymer has a PDI value of 1.

Another common characteristic of lignin is hydroxyl group content. Most of the hydroxyl groups in lignin are phenolic hydroxyl groups, in other words, aromatic hydroxyl groups. Hydroxyl group context is determined as the number of hydroxyl groups in mols per gram of dry lignin. Hydroxyl group context is determined by nuclear magnetic resonance (NMR) methods.

The method for producing a composition from which lignin epoxide adduct (EpL) may be obtained disclosed in this invention is based on epoxide addition to lignin. Epoxide addition is a chemical reaction more specifically, an addition reaction that results in an epoxide adduct. Epoxide addition to lignin results in the modification of lignin hydroxyl groups by epoxide. In other words, epoxide addition to lignin results in the decoration of lignin hydroxyl groups with epoxide. Lignin epoxide addition, also called epoxide addition to lignin reaction, results in a product defined here as lignin epoxide adduct, abbreviated EpL. Thus, EpL is a lignin derivative comprising an epoxide-modified lignin.

In other words, EpL may be represented by the formula Lignin-O—CH2-CH(R)—OH, where R is hydrogen or an aromatic or an aliphatic hydrocarbon moiety or a combination thereof. In an embodiment in step (i) epoxide is a linear or cyclic C1-C18 alkane, alkene or alkyn.

Epoxide is a chemical compound comprising a three-membered ring consisting of one oxygen atom and two carbon atoms. Epoxide according to current invention can be represented by the chemical formula CH2-O—CH—R, where R is hydrogen or an aromatic or an aliphatic hydrocarbon moiety or a combination thereof, preferably R is a hydrogen or an aliphatic hydrocarbon, even more preferably R is a hydrogen or an alkyl.

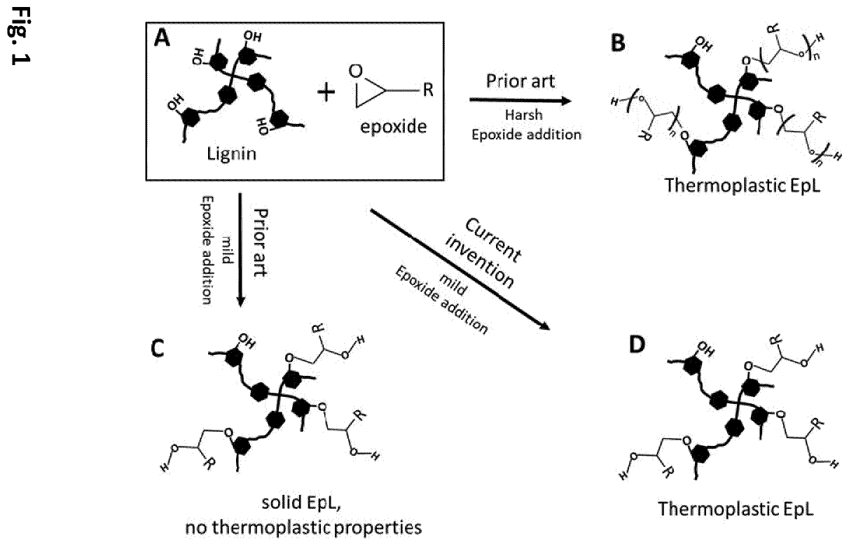

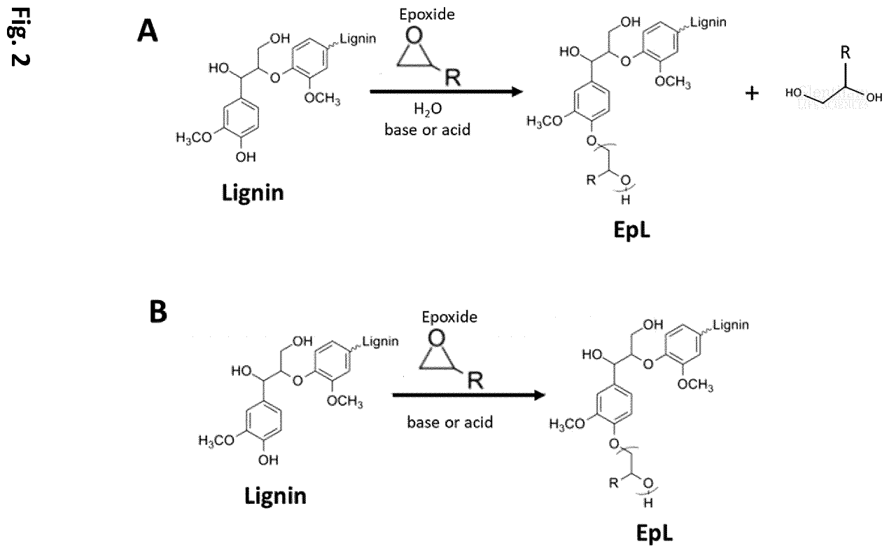

Chemical structures of epoxide and EpL according to the current invention are schematically presented in FIG. 2A.

A non-limiting example of an epoxide according to the current invention is alkylene oxide. Alkylene oxide is epoxide that can be represented by the chemical formula CH2-O—CH—R, where R is a hydrogen or an alkyl. Examples of alkylene oxide are ethylene oxide, propylene oxide, butylene oxide, or 2,3-epoxy-1-propanol. 30 The efficiency of epoxide addition is determined here as a percentage of the decorated phenolic hydroxyl groups in the total amount of phenolic hydroxyl groups that were present in lignin before the epoxide addition.

The high reactivity of epoxide is provided by the chemical properties of the three-membered ring, therefore epoxides with different side chains (—R) are expected to react similarly with lignin. Moreover, given that small aliphatic side chains attached to lignin according to the method disclosed in the current invention provide thermoplastic properties to the adduct, it is reasonable to expect that larger hydrophobic side chains such as aromatic hydrocarbon chains or chains comprising a combination of aromatic and aliphatic moieties will also provide thermoplastic properties to the respective lignin epoxide adduct obtained according to the method of the current invention.

A non-limiting example of an epoxide addition reaction is the hydroxy alkylation reaction or hydroxy alkylation. Hydroxy alkylation is a chemical reaction, that results in a hydroxyalkyl product. Hydroxy alkylation is an epoxide addition reaction where the resulting lignin epoxide adduct may be represented by the formula Lignin-O—CH2-CH(R)—OH, where R is an alkyl.

Thus in one aspect, the current invention is a method related to hydroxy alkylation of lignin.

In this aspect, the current invention discloses a method for producing a composition from which hydroxy alkylated lignin with thermoplastic properties may be obtained the method comprises the following steps:
(i) contacting a lignin dispersion with an alkylene oxide, wherein the lignin dispersion comprises lignin and at least one dispersant, wherein lignin is characterized by an average molecular weight Mw below 2 kDa and a polydispersity index between 1 and 2.

Epoxides can undergo polymerization, also called homopolymerization, forming a homopolymer, which is a polyether.

Thus, homopolymer of epoxide is a product of the polymerization of the epoxide. Homopolymerization is a chemical addition reaction that can compete with epoxide addition to lignin.

Epoxide can also react with water via a water addition reaction forming a glycol. Glycol is the product of the water addition reaction with epoxide. Glycol is a diol. The structure of the glycol formed by water addition to the epoxide according to the current invention is depicted in FIG. 2B. Water addition to epoxide can also compete with epoxide addition to lignin.

Mild epoxide addition to lignin is the process of epoxide addition wherein homopolymerization of the epoxide is minimal. More specifically, the mild epoxide addition, also called epoxide addition reaction carried out under mild conditions, is defined in this invention as a method for producing a composition from which EpL may be obtained wherein not more than 10% of the epoxide contacted with lignin is converted to a homopolymer during the addition reaction.

As a result of mild epoxide addition, the EpL comprises added side chains that are predominantly monomeric. More specifically, more than 90% of the added side chains covalently attached to lignin are monomeric ether moieties derived from the epoxide as depicted in FIG. 2A.

On the contrary, harsh epoxide addition to lignin is the process of epoxide addition wherein substantial homopolymerization of the epoxide takes place.

In other words, harsh epoxide addition is the harsh epoxide addition reaction, wherein the products of the reaction comprise homo-polymeric or homo-oligomeric chains of the epoxide. These chains may or may not be attached to lignin. These chains may contain the same or different epoxide units depending on the reaction composition. In a non-limiting example, if epoxide comprises propylene oxide and ethylene oxide, the respective homopolymer may contain hydroxy propylene and hydroxy ethylene units.

More specifically, the harsh hydroxy alkylation is defined in this teaching as the process of epoxide addition wherein more than 10% of the epoxide contacted with lignin is converted to homopolymer during the addition reaction.

Thus EpL obtainable by harsh epoxide addition comprises a copolymer of lignin covalently bound with a polyether.

Those skilled in the art would know or easily find out which addition reaction conditions will support harsh or mild epoxide addition. In general, higher pressure, higher temperature, and the absence of water in the addition reaction would drive the reaction toward the harsh addition.

Thermoplastics, also called materials with thermoplastic properties or substances with thermoplastic properties are materials that can be softened upon heating to a flowable liquid, cooled, and then reheated reversibly without affecting their inherent properties. Thus EpL with thermoplastic properties is defined here as EpL which upon heating becomes flowable, in other words, heating EpL to a certain temperature, such as temperature between 50 and 150 degrees Celsius, more preferably between 50 and 100 degrees Celsius, even more preferably between 50 and 80 degrees Celsius, would result in a decrease of its viscosity sufficiently for the material to adopt the shape of the vessel within 10 min, while upon cooling the EpL will solidify. And the cycles of melting and solidifying can be repeated several times, specifically at least two times without changing the chemical composition and properties of EpL.

Lignin-based materials are often characterized by a glass-transition temperature.

The glass-liquid transition, or glass transition, is the gradual and reversible transition in amorphous materials such as lignin-based material from a hard and relatively brittle “glassy” state into a viscous or rubbery state as the temperature is increased. The presence of the glass transition phenomenon does not mean that the material is thermoplastic, as glass transition may not result in a material that is flowable. For example, chemically unmodified lignin undergoes glass transition at a certain temperature, however, it is not becoming flowable upon further heating. Thus, materials characterized by a glass transition temperature are not necessarily thermoplastic.

The composition from which EpL with thermoplastic properties may be obtained is also referred to as composition comprising Lignin epoxide adduct (EpL) with thermoplastic properties or the composition containing EpL according to the current invention.

Thus in an aspect the invention relates to a method for producing a composition comprising Lignin epoxide adduct (EpL) with thermoplastic properties, the method comprising the step:
(i) contacting a lignin dispersion with an epoxide to obtain a composition comprising EpL, wherein the lignin dispersion comprises lignin and at least one dispersant, wherein lignin is characterized by an average molecular weight Mw below 2 kDa and a polydispersity index between 1 and 2. It is understood that by selecting the average weight of the lignin of below 2 kDa and the polydispersity index to be between 1 and 2, the EpL in the thus obtained composition has thermoplastic properties when isolated. In an embodiment at least one dispersant is water. In an embodiment less than 10% of the epoxide is converted to a homopolymer of the epoxide during step (i). Reducing the percentage of homopolymer of the epoxide is desirable as it means a greater percentage of the mass is derived from lignin, and thus there is a higher percentage of biomass in the final product.

In an embodiment the reaction of step (i) is carried out under atmospheric pressure. For example the reaction is carried out at a pressure of at least 0.8 bar, preferably 0.9 or even at least 0.95 bar. Preferably the reaction is carried out at most 2 bars, preferably at most 1.5, 1.4, 1.2 or even at most 1.1 bar. Carrying out step (i) between 0.8 and 1.5 bar are deemed mild conditions.

In an embodiment, the reaction of step (i) is carried out at a temperature below 100° C., preferably at a temperature below 99 C, 90° C., 80 C, 70° C., 60 C, 50° C., or even 45° C.

In an embodiment, the reaction of step (i) is carried out at a temperature above 0° C., more preferably above 10° C., 20 C, 30° C., or even 35° C. Temperatures between 0° C. and 100° C. are deemed mild conditions.

In an embodiment the lignin of the dispersion of step (i) is characterized by a content of phenolic hydroxyl groups equal to or higher than 2.5 mmol per gram of lignin dry weight. In an embodiment the lignin of the dispersion of step (i) is obtained by a method comprising ultrafiltration. In an embodiment the lignin of the dispersion of step (i) is obtained by a method comprising enzymatic oxidation.

In an embodiment the composition comprising Lignin epoxide adduct (EpL) with thermoplastic properties as obtained by the method of the invention additionally comprises glycol produced by water addition to the epoxide.

In a second aspect the invention relates to a composition comprising Lignin epoxide adduct with thermoplastic properties obtained or obtainable by the method according to the first aspect of the invention.

In a third aspect the invention relates to a lignin epoxide adduct (EpL) with thermoplastic properties, wherein more than 90% of the epoxide units covalently attached to lignin by the epoxide addition reaction are monomeric ether moieties derived from the epoxide.

In one embodiment, the composition containing EpL according to the current invention is obtained by contacting a lignin dispersion with an epoxide under alkaline conditions, preferably at pH above 8, more preferably at pH between 9 and 11. Examples 4 and 5 describe embodiments wherein sodium hydroxide was used as a base, and example 3 describes an embodiment where liquid ammonia was used as a base. In all three examples, epoxide addition to lignin was carried out at the same temperature and for the same time duration and resulted in more than 95% epoxide addition efficiency. Thus the method according to the current invention can be carried out in the presence of metal hydroxides or other bases.

In one embodiment of the invention described in example 6, the addition reaction comprised approximately equal molar amount of lignin phenolic hydroxyl groups and epoxide molecules. In other words the addition reaction was carried out at an approximately equimolar ratio of epoxide and lignin phenolic hydroxyl groups. Nevertheless, the epoxide addition efficiency acceded 95%, thus almost all of the lignin phenolic groups were decorated by the epoxide. After the removal of water and unreacted epoxide by evaporation at 60 degrees C., the reaction product comprised more than 90% EpL. Thus chemically pure lignin epoxide addict decorated with monomeric epoxide can be obtained with very simple purification such as the removal of volatile components by evaporation. The resulting EpL had a high viscosity even at elevated temperatures, more specifically its viscosity at 60 degrees Celsius was 50 000 cps.

Similar experiments were carried out with other epoxides, more specifically—with ethylene oxide, propylene oxide, butylene oxide or 2,3-epoxy-1-propanol. The respective EpL after evaporation of water and water and unreacted epoxide represented EpL with more than 90% purity, the products had thermoplastic properties. A viscosity of less than 50 000 cps could be achieved for all of these EpLs at temperatures below 100° C. At room temperature, all of these EpLs solidified. Further purification of the EpLs was possible by evaporation of the main side product of the reaction—the glycol formed by the reaction of the epoxide with water. For example, propylene glycol could be evaporated at 188 degrees Celsius while EpLs remained stable and chemically unchanged at this temperature. Up to 99% pure EpLs with thermoplastic properties could be obtained by this method.

In general, a thermoplastic material should have a low melt viscosity and thus good processability and high thermal stability. EpL obtained from the composition according to the current invention becomes flowable at temperatures below 100° C., typically even below 60° C. EpL obtained from the composition according to the current invention typically can be heated up to 200° C. without noticeable changes in its chemical composition and properties.

This remarkable thermostability allows the removal of low-molecular-weight impurities or side-products such as alkylene glycol by distillation at elevated temperatures.

The viscosity of the EpLs obtained by the method of the invention could be easily decreased by the addition of a solvent. The suitable solvent can be selected depending on the further application. Non-limiting examples of the solvents that can be used for decreasing the viscosity of the EpLs of the invention are ethylene glycol and propylene glycol.

It some embodiments of the current invention it was found beneficial to carry out the epoxide addition reaction with the access of the epoxide to the lignin hydroxyl groups in a reaction mixture comprising water. Under the conditions of the method disclosed here, access epoxide reacted with water and was converted to glycol (as depicted in FIG. 2B). Thus the method according to this embodiment allows simultaneous production of the EpL and the solvent for decreasing its viscosity. Examples 4 and 5 describe specific implementations of this embodiment. Products of the addition reactions in examples 4 and 5 after the removal of water and unreacted epoxide were characterized by the viscosity at room temperature of 2128 cps (example 4) and 5700 cps (example 5).

These compositions could be directly used as a polyol for rigid polyurethane foam production. Moreover, these compositions comprising EpL and propylene glycol could partly or fully replace the polyol component in polyurethane production and resulted in rigid foams with comparable properties to the foams made with conventional fossil-based polyols.

Thus the method of the invention relates also to producing a composition from which Lignin epoxide adduct (EpL) with thermoplastic properties may be obtained wherein the composition comprises additionally a glycol produced by water addition to the epoxide. The amount of glycol formed in the addition reaction could be tuned by the amount of access epoxide in the addition reaction. Consequently, the viscosity of the composition obtained after the removal of water and residual epoxide from the products of the addition reaction could be tuned by the amount of the access epoxide in the epoxide addition reaction.

In some embodiments, the epoxide addition reaction was carried out under acidic conditions. Generally, an epoxide addition reaction can be performed under alkaline or acidic conditions, the reaction becomes less efficient as the conditions approach neutral pH. We found that epoxide addition to lignin according to the method disclosed here is efficient at acidic pH below pH 5, preferably from 2 to 4. The experiment described in Example 5 was repeated as described apart from the pH of the lignin dispersion, which was adjusted to 3. The reaction efficiency and the product properties were similar to the ones obtained under the conditions described in example 5. Thus the method of the invention can be carried out under acidic or alkaline conditions. Acidic conditions are convenient in some cases especially if lignin fractionation to the desired molecular weight is achieved by acid precipitation of the high molecular weight lignin. In this case, lignin remaining in the solution may be suitable for the method disclosed here.

Besides, acidic conditions are convenient for the methods disclosed here when lignin is obtained by a method involving acid treatment. Such methods are commonly used for lignin extraction in biorefineries.

The method of the invention requires a lignin with special properties-more specifically a lignin characterized by low weight average molecular weight (Mw) and low polydispersity index PDI.

According to the method of the invention the phenolic hydroxyl groups of lignin are decorated (derivatized) by the epoxide. It is preferable that the lignin of the invention is characterized by a high phenolic hydroxyl group content. More specifically it is preferable that the phenolic group content of the lignin of the dispersion of step (i) is higher or equal to 2 mmol per gram lignin dry weight, more preferably higher or equal to 2.5 mmol per gram lignin dry weight.

Such lignin is obtainable by various methods. Those skilled in the art will know how to obtain low molecular weight lignin with a high hydroxyl content. Low molecular weight lignin is more soluble in polar solvents such as alcohols, acetone, and others, as compared to high molecular weight lignin. Low molecular weight lignin with high hydroxyl group content can also be obtained by acid precipitation, wherein high molecular weight lignin is precipitated at lower pH (more acidic conditions) than the desired low molecular weight lignin. Thus low molecular weight lignin can be obtained as a dispersion comprised in an acidic composition, which can directly be used according to the method of the invention.

The above-mentioned methods of obtaining low molecular weight lignin have been used in the prior art for obtaining EpL by mild epoxide addition, more specifically for obtaining hydroxypropylated lignin by mild hydroxypropylation (see e.g.Wu, et al, 2021. Extraction and oxypropylation of lignin by an efficient and mild integration process from agricultural waste. Industrial Crops and Products. 172. 114013). In these prior art teachings, the lignin epoxide adducts did not possess thermoplastic properties, apparently because the polydispersity index of the lignin was not sufficiently low.

In the process of identifying the critical features of the method of the invention, we performed multiple experiments of epoxide addition to lignin under mild conditions that did not result in a lignin epoxide adduct with thermoplastic properties. This is in spite of the fact that the epoxide addition in these experiments was highly efficient, with more than 90% of the lignin phenolic hydroxyl groups modified with epoxide. Some of these experiments are described in Examples 7 and 8, which underline the importance of both features put forward in the method of the invention—the lignin molecular weight and the polydispersity index.

In the example 7, the conditions of the method of the invention were fulfilled except for PDI value, which was not between 1 and 2. The effect of the invention was not achieved, the resulting EpL was not thermoplastic as defined in this teaching, in other words, EpL was not flowable at temperatures below 150° C.

This experiment underlines the importance of PDI being lower than 2 to obtain the effect of the invention, namely, to obtain lignin epoxide adduct with thermoplastic properties.

In the example 8, the conditions of the method of the invention were fulfilled except for the weight average molecular weight of the lignin, which was not below 2 kDa. The effect of the invention was not achieved, the resulting EpL was not thermoplastic as defined in this teaching, in other words, EpL was not flowable at temperatures below 150° C.

It was not known in the art prior to the current invention that the polydispersity index plays a crucial role in conferring thermoplastic properties to the lignin epoxide adduct. In one embodiment of the current invention the lignin dispersion according to the method disclosed here was obtained by membrane ultrafiltration (see example 1). In other words, lignin with the desired molecular weight and polydispersity index was obtained by membrane separation.

The amount of low-molecular-weight lignin suitable for the method of the current invention in a lignin dispersion can be increased by lignin depolymerization. The term “depolymerization” as used herein is meant to refer to a process wherein the molecular weight of a lignin molecule decreases. This may be caused by opening covalent bonds between monomers, oligomers and polymers or between polymers and oligomers. Depolymerization may therefore refer to a process that results in an increase of low molecular weight species of lignin and a decrease of high molecular weight species of lignin.

In one embodiment, the lignin of the dispersion of step (i) according to the method of the invention was obtained by a method comprising enzymatic depolymerization. More specifically the lignin of the dispersion of step (i) according to the method of the invention was obtained by a method comprising lignin oxidation by a laccase as described in example 2.

Thus, the current invention refers to
(i) Method for producing a Lignin epoxide adduct (EpL) comprising a step of contacting a lignin dispersion with an epoxide to obtain EpL, wherein the lignin dispersion comprises lignin and at least one dispersant, and wherein the lignin is characterized by an average molecular weight Mw below 2 kDa and a polydispersity index between 1 and 2.
(ii) Method according to method (i) wherein lignin epoxide adduct has thermoplastic properties.
(iii) Method according to methods (i) or (ii) wherein contacting lignin dispersion with an epoxide is carried out under mild conditions.
(iv) Method according to any of the methods (i-iii) wherein at least one dispersant is water.
(v) Method according to any of the methods (i-iv) wherein less than 10% of the epoxide is converted to a homopolymer of the epoxide during the contacting lignin dispersion with an epoxide.
(vi) Method according to any of the methods (i-v), wherein contacting lignin dispersion with an epoxide is carried out under atmospheric pressure.
(vii) Method according to any of the methods (i-vi) wherein the lignin dispersion has alkaline pH, preferably pH between 8 and 11, preferably between 8.5 and 10, more preferably between 9 and 10.5
(viii) Method according to any of the methods (i-vii) wherein the lignin dispersion has acidic pH, preferably pH between 2 and 5, preferably between 2 and 4.
(ix) Method according to any of the methods (i-viii) wherein the epoxide can be represented by chemical formula CH2-O—CH—R where R is hydrogen or an aromatic or an aliphatic hydrocarbon moiety or a combination thereof.
(x) Method according to any of the methods (i-ix) wherein the epoxide can be represented by chemical formula CH2-O—CH—R where R is an aliphatic hydrocarbon moiety or hydrogen.
(xi) Method according to any of the methods (i-x) wherein the epoxide can be represented by chemical formula CH2-O—CH—R where R is an alkyl or hydrogen.
(xii) Method according to any of the methods (i-xi) wherein the epoxide is ethylene oxide, propylene oxide, butylene oxide or 2,3-epoxy-1-propanol (xiii) Method according to any of the methods (i-xii) wherein the lignin of the dispersion is characterized by a content of phenolic hydroxyl groups equal to or higher than 2.5 mmol per gram of lignin dry weight.
(xiv) Method according to any of the methods (i-xiii) wherein lignin of the dispersion is obtained by a method comprising ultrafiltration.
(xv) Method according to any of the methods (i-xiv) wherein lignin of the dispersion is obtained by a method comprising enzymatic oxidation.
(xvi) Method according to any of the methods (i-xv) wherein the composition obtained by contacting a lignin dispersion with an epoxide additionally contains a glycol produced by water addition to the epoxide.
(xvii) A composition comprising Lignin epoxide adduct with thermoplastic properties obtainable by a method according to any of the methods (i-xvi).
(xviii) A lignin epoxide adduct with thermoplastic properties obtainable by a method according to any of the methods (i-xvi).
(xix) A lignin epoxide adduct (EpL) with thermoplastic properties, wherein more than 90% of the side chains in the EpL covalently attached to lignin by the epoxide addition reaction are monomeric ether moieties derived from the epoxide.

### EXAMPLES

### Example 1: Preparation of Alkali-Soluble or Acid-Soluble Lignin

Hardwood lignin was obtained from an industrial source (Sweetwater Inc.). Alkali-soluble lignin was prepared as follows: Hardwood lignin was solubilized at 100 g/l in 0.25 M NaOH, mixed for 30 minutes at room temperature, centrifuged at 6000 g for 20 minutes and the supernatant was dried in an oven at 105° C. and stored at room temperature until used. The dried alkaline-soluble lignin was then dissolved to completion at 25 g/l in water and the pH was adjusted to 10.5. Alkaline soluble lignin was further used for size separation by membrane ultrafiltration and further for the method of the invention carried out under alkaline conditions.

Acid-soluble lignin was obtained by the same procedure apart from that the lignin was solubilized in a solution comprising acid. Acid-soluble lignin was further used for size separation by membrane ultrafiltration and further for the method of the invention carried out under acidic conditions.

### Example 2

Preparation of the lignin with an average molecular weight Mw below 2 kDa and a polydispersity index between 1 and 2:

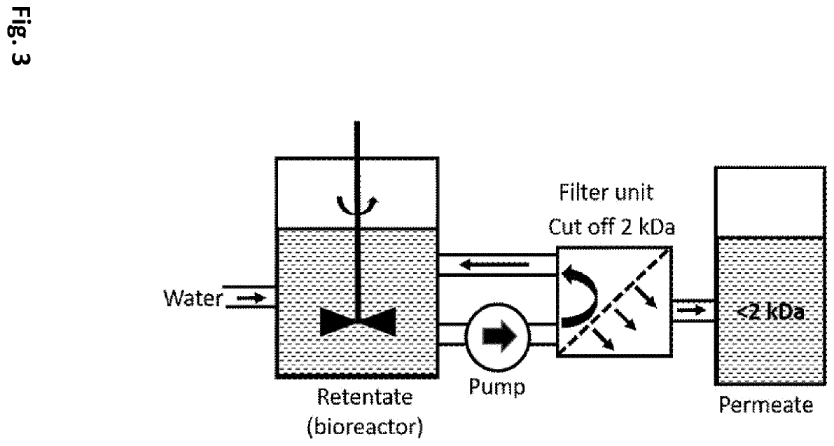

Alkali-soluble lignin prepared as described above was dissolved in 750 ml water to the final concentration of 25 g/L to obtain a lignin solution. The reaction was run in 1 L twin-pot bioreactor (BIOSTAT® B plus twin from Sartorius Stedim Biotech). The reactor with lignin solution was equilibrated to 50° C., and pH 10.5. After that, the continuous filtration as depicted in FIG. 3 was carried out for 1 h. The mixture comprising lignin was continuously circulated through a tangential flow membrane unit Vivaflow 200 (Sartorius) with polyethersulfone membranes with 2 kDa cut-off value. The filtration unit was used according to the manufacturer's protocol (2.5 bar pressure, 200-400 ml/min retentate flow/module). While the mixture was circulated through the filtration unit, the conditions (pH and temperature) were maintained in the reactor and the mixture was replenished with water to keep the volume in the reactor constant.

The permeate accumulation rate was approximately 2 L/h, thus the whole reaction volume was replaced in approximately 20 min. Samples were analyzed by HPLC. To normalize the volumes of different fractions (starting material, retentate, and permeate) for HPLC analysis, the retentate sample was used undiluted, permeate sample was diluted with water 1:0.1, starting material sample was diluted with water 1:10.6.

All three samples were further diluted 1:4 with 0.1M NaOH for HPLC injection. Based on the HPLS profile, weight-average molecular weight and number-average molecular weight and polydispersity index were calculated as described in example 3.

In one embodiment the mixture in the bioreactor contained a lignin oxidizing enzyme, more specifically an alkaline laccase. In this case, the reactor with lignin solution was equilibrated to 50° C., and pH 10.5 with aeration at a rate of 0.16 l/min. After that, the enzyme was added to an amount of 800 nkatal/gram of lignin (~50 U/gram of lignin). The reaction was continued for 1 h in a batch mode with constant aeration at a rate of 0.16 l/min. The dissolved oxygen level was maintained at a constant level from the time of enzyme addition and the pH was controlled with NaOH to remain at 10.5 throughout the reaction. After one hour, the reaction was switched to continuous filtration mode as described above and was continued for 4 hours (thus total reaction time was 5 h). This method comprising enzymatic oxidation of lignin was used when linin preparation comprised a large quantity of high-molecular-weight lignin.

Several different lignin sources were tested with this method including biorefinery lignin, and Kraft lignin from soft and hardwood. In all cases, the permeate of the ultrafiltration contained lignin with an average molecular weight Mw below 2 kDa and a polydispersity index between 1 and 2

### Example 3

### Size Exclusion HPLC

Size exclusion chromatography for lignin samples and molecular weight standards was performed using HPLC chromatographer 120 Compact LC with UV detector (Agilent Technologies), equipped with a size exclusion column MCX 1000 Angstrom 5 μm, 8×300 mm and with pre-column MCX 5 μm, 8×50 mm (Polymer Standards Service). Isocratic mode with 0.1M NaOH eluent flow 0.5 ml/min at room temperature was used; the run time was 40 min. The detection was performed at 358 nm. Molecular mass standards (polystyrene sulfonate sodium salt standards Mp=~0.9 to ~65 kDa, Polymer Standards Service) were monitored at 254 nm. Data were acquired with EzChrom Elite Compact software.

Primary HPLC traces acquired with Agilent EZChrom Elite software were transferred to tailor-made MS Excel spreadsheets for further processing. Signal versus retention time graphs were produced from 1 Hz time series to depict the chromatography traces. Polystyrene sulfonate Molecular mass standards (Polymer Standards Service), ranging in mass at peak maximum from MW=~900 to ~65000, and syringaldehyde (MW 182) were used for calibration of molecular weights.

Based on the HPLS profile, weight-average molecular weight Mw, number-average molecular weight Mn and polydispersity index were calculated.

$$M n = \sum {N}_{i} {M}_{i} / \sum {N}_{i}$$

$$Mw = \sum {N}_{i} {M}_{i}^{2} / \sum {N}_{i} {M}_{i}$$

where Mᵢ is the molecular weight of a chain and Nᵢ is the number of chains of that molecular weight.

### Example 4

The lignin used in this example was Kraft lignin from softwood. Kraft lignin was subjected to size separation by ultrafiltration essentially as described in Example 2. The resulting lignin had the following specifications:
Average molecular weight (Mw) 0.5 kDa,
Polydispersity index (PDI) 1.5
Phenolic hydroxyl groups content 3.93 mmol/g,
Lignin epoxide adduct was obtained as follows:
160 ml of 2M NaOH was poured into the 1000 ml three-neck round-bottom flask (reactor) with a thermometer and pH probe, magnetic mixing bar, and reflux condenser with a continuous cold-water circulation. The reactor was placed in a fume hood. The reactor was furnished with a heating mantle (1000 ml volume), equipped with a stirrer and temperature controller. Afterward, 150 g of lignin (dry matter 76.5 wt %) was slowly added to the flask and stirred until complete solubilization was reached. Then, 15 ml of 10M NaOH and 41.5 ml of deionized water were added to the mixture. The pH of the mixture was 10, and the lignin concentration was adjusted to 200 g/l by the addition of water. The mixture was then stirred for 30 min to assure the pH level stabilization. In the next step, 321.8 ml of propylene oxide (PO) was added to the reactor. Then, the reaction mixture was heated to 40° C. and continuously stirred for 18 hours. Thus, the composition from which EpL may be obtained was produced according to the method of the invention, in other words, the composition according to the method of claim 1 in this embodiment was obtained.

The composition was further subjected to rotary evaporation at 60° C. under a vacuum until the water was completely evaporated. The remaining liquid material was analyzed and contained hydroxy alkylated lignin with more than 95% phenolic hydroxyl group of lignin modified by epoxide addition, thus epoxide addition efficiency was more than 95%, and the second component present in the composition was propylene glycol. Propylene glycol was the product of the reaction of propylene oxide with water. This side reaction was much slower than the reaction of epoxide with lignin and did not affect the epoxide addition to lignin efficiency.

The composition obtained after water and residual epoxide evaporation had a viscosity of 2128 cps at room temperature and could be directly used as a polyol for rigid polyurethane foam production. This composition comprising EpL and propylene glycol could fully replace the polyol component in polyurethane production and resulted in rigid foams with comparable properties to the foams made with conventional fossil-based polyols.

For further analysis of the EpL, propylene glycol was removed from the composition by evaporation in the oven at 188° C.

The EpL obtained after propylene glycol removal was solid at room temperature and became flowable at temperatures between 55° C. and 60° C.

This EpL was further heated to 200° C. without noticeable changes in its chemical composition and properties.

### Example 5

Hardwood lignin was obtained from an industrial source (Sweetwater Inc.), this biorefinery lignin was obtained by extrusion of hardwood chips under slightly acidic conditions (Sunburst™ technology). This lignin was subjected to size separation by ultrafiltration essentially as described in example 2.

The resulting lignin had the following specifications:
Average molecular weight (Mw) 0.8 kDa,
Polydispersity index (PDI) 1.6
Phenolic hydroxyl groups content 3.68 mmol/g,
Lignin epoxide adduct was obtained as follows:
300 ml of 1M NaOH was poured into the 1000 ml three-neck round-bottom flask (reactor) with a thermometer and pH probe, magnetic mixing bar, and reflux condenser with a continuous cold-water circulation. The reactor was placed in a fume hood. The reactor was furnished with a heating mantle (1000 ml volume), equipped with a stirrer and temperature controller. Afterward, 213 g of lignin (dry matter 84.5 wt. %) was slowly added to the flask and stirred until complete solubilization was reached. Then, 10 ml of 10M NaOH and 50.25 ml of deionized water were added to the mixture. The pH of the mixture was 9, and the lignin concentration was adjusted to 200 g/L by the addition of water. The mixture was stirred for 30 min to assure the pH level stabilization. In the next step, 506.7 ml of propylene oxide (PO) was added to the reactor. Then, the reaction mixture was heated to 40° C. and continuously stirred for 18 hours.

Thus, the composition from which EpL may be obtained was produced according to the method of the invention, in other words, the composition according to the method of claim 1 in this embodiment was obtained.

The composition was further subjected to rotary evaporation at 60° C. under a vacuum until the water was completely evaporated. The remaining liquid material was analyzed and contained hydroxy alkylated lignin with more than 95% phenolic hydroxyl group of lignin modified by epoxide addition, thus epoxide addition efficiency was more than 95%, and the second component present in the composition was propylene glycol. Propylene glycol was the product of the reaction of propylene oxide with water. This side reaction was much slower than the reaction of epoxide with lignin and did not affect the epoxide addition to lignin efficiency.

The composition obtained after water and residual epoxide evaporation had a viscosity of 5700 cps at room temperature and could be directly used as a polyol for rigid polyurethane foam production. This composition comprising EpL and propylene glycol could fully replace the polyol component in polyurethane production and resulted in rigid foams with comparable properties to the foams made with conventional fossil-based polyols.

For further analysis of the EpL, propylene glycol was removed from the composition by evaporation in the oven at 188° C.

The EpL obtained after propylene glycol removal was solid at room temperature and became flowable at temperatures between 55° C. and 60° C.

This EpL was further heated to 200° C. without noticeable changes in its chemical composition and properties.

Viscosity in this and further examples was measured by the “Haake viscotester C” instrument (Thermo Scientific) according to the standard procedure.

This is a rotational viscometer that measures the resistance of a test substance against a preset speed. The resulting torque or resistance defines the viscosity of the fluid. The higher the torque, the higher the viscosity.

### Example 6

The lignin used in this example was Kraft lignin from softwood. Kraft lignin was subjected to size separation by ultrafiltration essentially as described in example 2. The resulting lignin had the following specifications:
Average molecular weight (Mw) 1.3 kDa,
Polydispersity index (PDI) 1.3
Phenolic hydroxyl groups content 2.9 mmol/g,
Lignin epoxide adduct was obtained as follows:
100 ml of 1% of NH3 solution was poured into the 1000 ml three-neck round-bottom flask (reactor) with a thermometer and pH probe, magnetic mixing bar, and reflux condenser with a continuous cold-water circulation. The reactor was placed in a fume hood. The reactor was furnished with a heating mantle (1000 ml volume), equipped with a stirrer and temperature controller. Afterward, 62.5 g of lignin (dry matter 80.02 wt. %) was slowly added to the flask and stirred until complete solubilization was reached. Then, 60 ml of 28% NH₃ solution and 51.7 ml of deionized water were added to the mixture. The pH of the mixture was 10.5, and lignin concentration was adjusted to 200 g/L by the addition of water. The mixture was stirred for 30 min to assure the pH level stabilization. In the next step, 25.9 ml of propylene oxide (PO) was added to the reactor. Then, the reaction mixture was heated to 40° C. and continuously stirred for 18 hours. Thus the composition from which EpL may be obtained was produced according to the method of the invention, in other words, the composition according to the method of claim 1 in this embodiment was obtained.

The composition was further subjected to rotary evaporation at 60° C. under vacuum until the water was completely evaporated. The remaining liquid material was analyzed and contained hydroxy alkylated lignin with more than 95% phenolic hydroxyl group of lignin modified by epoxide addition, thus epoxide addition efficiency was more than 95%, and the second component present in the composition was propylene glycol. In this example only a small amount of the amount propylene glycol was formed during the addition reaction due to the reaction stoichiometry, more specifically propylene glycol comprised less than 10% w/w of the EpL. Residual propylene glycol could be removed by evaporation in the oven at 188° C.

The resulting EpL was further heated to 200° C. without noticeable changes in its chemical composition and properties.

The viscosity of the obtained EpL could be reduced to the desired level by the addition of propylene glycol. This mixture of EpL and propylene glycol was directly used as a polyol for rigid polyurethane foam production and could fully replace the polyol component in the polyurethane production resulting in rigid foams with comparable properties to the foams made with conventional fossil-based polyols.

### Example 7

Kraft lignin from softwood that was used as starting material in Example 4 (before membrane size separation) was also used for this experiment. Weight average molecular weight (Mw) of the lignin was 7.54 kDa and PDI 2.8. In order to prepare a sample with lower average molecular weight, lignin was subjected to acidification causing precipitation of high molecular weight lignin. Low-molecular-weight lignin was then further purified by acid precipitation.

For this, black liquor was diluted with water to 5% dry matter content, and 5 M sulfuric acid was added slowly with continuous mixing. The pH of the reaction mixture was continuously monitored. Initial pH was 11.7. A sample was taken when pH level reached pH 10, the sample was centrifuged in an Eppendorf tube at 15 000 g for 5 min and the supernatant was analyzed by HPLC to determine weight average molecular weight and polydispersity index of the lignin remaining in solution. During this measurement the addition of the acid to the lignin preparation was paused. After the measurement, slow addition of sulfuric acid was continued and samples analyzed the same way as the previous sample when pH value reached pH9, and again, when it reached pH 8. At pH 8, extensive precipitation was observed in the reaction mixture and the lignin remaining in solution was characterized by weight average molecular weight 1.8 kDa and polydispersity index (PDI) 3.1. The entire reaction mixture was filtered to remove precipitated lignin, the precipitate was discarded. The filtrate containing the low-molecular-weight lignin was used for further experiments. Addition of the sulfuric acid was continued until the reaction mixture reached pH 2 and virtually all lignin was precipitated. The precipitate was collected by filtration and washed with water to remove salts and other impurities from lignin.

The filtrate was then dissolved in 2M NaOH at the concentration 250 g/L, the pH was adjusted to pH10 with 10M NaOH, the mixture was then stirred for 30 min to assure the pH level stabilization. Then the lignin concentration was adjusted with water to 200 g/l as determined by HPLC, the average molecular weight and PI were also confirmed, and hydroxyl content measured. This material was further used for the epoxide addition reaction.

The resulting lignin had the following specifications:
Average molecular weight (Mw) 1.9 kDa,
Polydispersity index (PDI) 3.2
Phenolic hydroxyl groups content 3.1 mmol/g, aliphatic hydroxyl groups content 0.69 mmol/g

The epoxide addition reaction was performed essentially as described in Example 4. Specifically, 500 ml of lignin solution at 200 g/L was poured in the 1000 ml three-neck round-bottom flask (reactor) with thermometer and pH probe, magnetic mixing bar and reflux condenser with continuous cold-water circulation. The reactor was placed in a fume hood. The reactor was furnished with a heating mantle (1000 ml volume), equipped with a stirrer and temperature controller. Propylene oxide (PO), 280 ml was added in the reactor. Then, the reaction mixture was heated to 40° C. and continuously stirred for 18 hours. In the resulting mixture only about 70% of phenolic hydroxyl groups were modified by the addition of propylene oxide.

To further increase the hydroxypropylation efficiency, the reaction mixture was then transferred to a 2 L flask and another 280 ml of propylene oxide was added to the reaction and the reaction continued for 18 h with stirring at 40° C., then another 280 ml of propylene oxide was added to the reaction and the reaction continued for 18 h with stirring at 40° C. The composition was further subjected to rotary evaporation at 60° C. under vacuum until the water and remaining propylene oxide was completely evaporated. The remaining liquid material was analyzed and contained hydroxyalkylated lignin with more than 95% phenolic hydroxyl group of lignin modified by epoxide addition.

Thus epoxide addition efficiency was more than 95%, however the hydroxypropylation reaction proceeded slower, and more propylene oxide needed to be used, as compared to the example 4, where a comparable lignin was used. Consequently, more of the side product propylene glycol was formed by reacting propylene oxide with water.

After the removal of water and residual propylene oxide, the resulting mixture had rather low viscosity of 1500 cps at room temperature due to large amount of propylene glycol.

For further analysis of the EpL, propylene glycol was removed from the composition by rotor evaporation at 188° C. However, during this process, as the amount of propylene glycol was lowering, the mixture solidified even at such a high temperature and was not flowable.

Thus, the conditions of the method of the invention were fulfilled except for PDI value, which was not between 1 and 2. The effect of the invention was not achieved.

This experiment underlines the importance of PDI being lower than 2 to obtain the effect of the invention, namely, to obtain lignin epoxide adduct with thermoplastic properties.

### Example 8

Kraft lignin from softwood that was used as starting material in Examples 4 (before membrane size separation) and in Example 7, was also used for this experiment. Weight average molecular weight (Mw) of the lignin in was 7.54 kDa and PDI 2.8. In order to prepare a sample with a lower PDI, lignin was subjected to membrane separation to remove low-molecular-weight lignin. Ultrafiltration was performed essentially as described in example 2, with the exception that 5 kDa cut-off membrane was used instead of 2 kDa membrane, and retentate, not permeate, was used for further experiment. Thus lower molecular weight lignin was removed from the lignin preparation.

The resulting lignin had the following specifications:
Average molecular weight (Mw) 8.2 kDa,
Polydispersity index (PDI) 1.8
Phenolic hydroxyl groups content 3.1 mmol/g, aliphatic hydroxyl groups content 0.71 mmol/g

The lignin was dried at 40° C. in rotor evaporator under vacuum.

Prior to the epoxide addition reaction, the lignin was dissolved in 2M NaOH at the concentration 250 g/L, the pH was adjusted to pH10 with 10M NaOH, the mixture was then stirred for 30 min to assure the pH level stabilization. Then the lignin concentration was adjusted to 200 g/l.

The epoxide addition reaction was performed as described in Example 7, except that incubation time was further extended to 30 h after each addition of propylene oxide. After this extended procedure, more than 90% of phenolic hydroxyl groups in lignin were modified by the addition of propylene oxide.

The composition was further subjected to rotary evaporation at 60° C. under vacuum until the water was completely evaporated.

Further removal of propylene glycol (the side product of the reaction) by rotor evaporation at 188° C. caused the mixture to solidify even at such a high temperature. Thus, the conditions of the method of the invention were fulfilled except for the weight average molecular weight, which was not below 2 kDa. The effect of the invention was not achieved.

This experiment underlines the importance of Mw being lower than 2 kDa to obtain the effect of the invention, namely, to obtain lignin epoxide adduct with thermoplastic properties.

1. A method for producing a composition comprising Lignin epoxide adduct (EpL) with thermoplastic properties, the method comprising the following:
(i) contacting a lignin dispersion with an epoxide to obtain a composition comprising EpL, wherein the lignin dispersion comprises lignin and at least one dispersant, wherein lignin is characterized by an average molecular weight Mw below 2 kDa and a polydispersity index between 1 and 2.

2. The method according to claim 1 wherein at least one dispersant is water.

3. The method according to claim 1 wherein less than 10% of the epoxide is converted to a homopolymer of epoxide during step (i).

4. The method according to claim 1, wherein the reaction of step (i) is carried out under pressure between 0.8 and 1.5 bar or at atmospheric pressure.

5. The method according to claim 1, wherein the lignin dispersion of step (i) has alkaline pH, preferably a pH between 8 and 11, a pH between 8.5 and 10, or a pH between 9 and 10.5.

6. The method according to claim 1, wherein the lignin dispersion of step (i) has acidic pH, a pH between 2 and 5, or a pH between 2 and 4.

7. The method according to claim 1, wherein in step (i) epoxide can be represented by chemical formula CH2-O—CH—R where R is hydrogen or an aromatic or an aliphatic hydrocarbon moiety or a combination thereof.

8. The method according to claim 1, wherein in step (i) epoxide can be represented by chemical formula CH2-O—CH—R where R is a linear or cyclic C1-C18 alkane, alkene, alkyn, or hydrogen.

9. The method according to claim 1, wherein in step (i) epoxide is ethylene oxide, propylene oxide, butylene oxide or 2,3-epoxy-1-propanol.

10. The method claim 1, wherein lignin of the dispersion of step (i) is characterized by a content of phenolic hydroxyl groups equal to or higher than 2.5 mmol per gram of lignin dry weight.

11. The method according to claim 1 wherein lignin of the dispersion of step (i) is obtained by a method comprising ultrafiltration.

12. The method according to claim 1, wherein lignin of the dispersion of step (i) is obtained by a method comprising enzymatic oxidation.

13. The method according to claim 1, wherein the composition from which Lignin epoxide adduct (EpL) with thermoplastic properties may be obtained comprises additionally a glycol produced by water addition to the epoxide.

14. A composition comprising Lignin epoxide adduct with thermoplastic properties obtained or obtainable by the method according to claim 1.

15. A lignin epoxide adduct (EpL) with thermoplastic properties, wherein more than 90% of the epoxide units covalently attached to lignin by the epoxide addition reaction are monomeric ether moieties derived from the epoxide.
